(19) United States
(12) Patent Application Publication
(10) Pub. No.: US 2007/0147039 A1
(43) Pub. Date: Jun. 28, 2007

(54) Method for creation of laser show utilizing effects of laser interaction with inflated lightweight objects

(76) Inventors: Igor Troitski, Henderson, NV (US); Anna Kharitonova, Baltimore, MD (US)

Correspondence Address: IGOR TROITSKI, 853 ARROWHEAD TRAIL, HENDERSON, NV, 89015, US

(21) Appl. No.: 11/317,379

(22) Filed: Dec. 27, 2005

(51) Int. Cl. F21S 6/00; G02B 27/20

(52) U.S. Cl. 362/259; 362/257

(57) ABSTRACT

Disclosed is a method wherein balloons with special shapes, surface materials and gases, which fill the balloons, are used for production of color dynamic visual effects generated by laser radiation. The visual effects include the creation of dynamic laser pictures on and inside the balloons, the generation of movement of the balloons at the desirable directions, and the destruction of the balloons. Destruction of the balloons is accompanied with desirable dynamic visual effects (blowing off, fragmentation, burning, and explosion) and can be produced so that if an inflated object contains other inflated objects then the internal inflated objects are not damaged and they can move freely at ambient space. Movement of a balloon is produced by creation of a gas flow from a hole, which is produced by laser radiation in a surface of a special auxiliary part of the general balloon. Dynamic pictures on a balloon surface and inside a balloon are created by using effects of laser interaction with surface material (fotoionization, creation of color centers, luminescence of fluorescent material or phosphorescent pigment), with ambient air and with the gas filling the balloon (air and gas breakdowns).

### FIELD OF THE INVENTION

The present invention relates to the laser technology, wherein effects of interaction of laser radiation with inflated lightweight objects are used for creation of a laser show.

### BACKGROUND OF THE INVENTION

Today laser show uses visible color laser beams for creation of color configuration by moving these beams at an area show. However, the show appeal will rise, if the show will use the numerous effects, generated during interaction of laser beams with special objects, particularly, with inflated lightweight objects (balloons) of special forms, surface material and auxiliary inflated parts, located inside the balloons and/or on the surfaces of the balloons.

Physical mechanisms of laser-material interaction are used for processing materials. There are numerous publications and patents disclosing corresponding methods. We will mention only several patents, which are more interesting for the present invention.

U.S. Pat. No. 3,941,973 to Luck, Jr., et al. reveals an apparatus for laser material removal from a work piece wherein optical means is provided for compressing portions of the beam.

U.S. Pat. No. 4,588,885 to Paul A. Lovoi, et al. discloses a method and apparatus for the removal of paint and the like from a substrate.

U.S. Pat. No. 4,734,550 to Imamura, et al. discloses a laser processing method comprises the steps of generating a pulsed laser beam having a substantially circular shape and scribing the surface of a work piece with the rectangular beam to form grooves therein.

U.S. Pat. No. 4,941,093 Marshall, et al. discloses laser apparatus for eroding a surface comprises means to select and control the, shape and size of the area irradiated by each pulse of laser energy without varying the energy density of the beam.

U.S. Pat. No. 5,786,560 to Tatah, et al. proposes a method of treating a material by generating an ultraviolet wavelength laser beam having femtosecond pulses. Apparatus includes a beam splitter for splitting the ultraviolet laser beam into a plurality of separate laser beams; directing the separate laser beams onto a target point within a sample such that the separate beams overlap to create an intensity sufficient to treat the sample.

U.S. Pat. No. 6,472,295 to Morris, et al. describes a method and apparatus for laser cutting a target material. The method includes the steps of generating laser pulses from a laser system and applying the laser pulses to the target material so that the laser pulses cut through the material.

J. F. Ready in his monograph “Effects of High-Power Laser Radiation” (Academic Press, New York, 1971) describes the general mechanisms of laser-induced breakdown at different mediums (transparent solid, liquid and gas mediums) and gives the large number of the breakdown threshold values.

Concetto R. Giuliano in “The relation between surface damage and surface plasma formation” (Damage in Laser Material, 1972) describes a number of experiments, in which entrance and exit surface laser-induced damages and plasmas, accompanying these damages, are studied.

Jhan M. Khan in “Surface Science and Surface Damage” (Damage in Laser Material, 1972) studies connection between surface characteristics and surface damages. “LIA Handbook of Laser Material Processing” (Laser Institute of America, Magnolia Publishing, Inc., 2001) contains complete information about all components for laser materials processing systems and describes the large number of physical mechanisms and effects of laser-material interaction.

Another field, where physical mechanisms of laser-material interaction are used, is the technology of laser-induced image creation.

Troitski in “Laser-Induced Image Technology: Yesterday, Today and Tomorrow”(SPIE Vol.5664, 2005, pages 293-301) describes the principals. of the laser-induced image technology, which are used today and will be used at the nearest future for creation of the laser images.

U.S. Pat. No. 6,087,617 to Troitski et al. discloses a computer graphic system for producing an image inside optically transparent material. An image reproducible inside optically transparent material by the system is defined by potential etch points, in which the breakdowns required to create the image in the selected optically transparent material are possible. The potential etch points are generated based on the characteristics of the selected optically transparent material. If the number of the potential etch points exceeds a predetermined number, the system carries out an optimization routine that allows the number of the generated etch points to be reduced based on their size. To prevent the distortion of the reproduced image due to the refraction of the optically transparent material, the coordinates of the generated etch points are adjusted to correct their positions along a selected laser beam direction.

U.S. Pat. No. 6,333,486 to Troitski discloses a method for production of etch points inside transparent material, which have the same size but different brightness. Laser-induced damages produced by this method provide the reproduction of image gradation without changing of their spatial resolution.

U.S. Pat. No. 6,399,914 to Troitski discloses a method for producing laser-induced images inside the special transparent material containing special kinds of impurities, which decrease the damage threshold of the material that provides creation of small and without star structure laser-induced damages.

U.S. Pat. No. 6,417,485 to Troitski discloses a method and laser system for producing laser-induced damages inside transparent materials by controlling breakdown process development. At the beginning an applied laser radiation level just exceeds an energy threshold for creating a plasma condition inside the transparent material, and thereafter the energy level of the applied laser radiation is just maintain the plasma condition and is applied before the plasma condition extinguished, but after a shock wave associated therewith has passed.

U.S. Pat. No. 6,426,480 to Troitski discloses a method and system for producing single layer laser-induced damage portrait inside transparent material which are based on generation of small smoothed etch points of determined sizes and on control of their brightness without variation of their determined sizes.

U.S. Pat. No. 6,490,299 to Raevski et al. discloses method and laser system producing high quality laser-induced images inside transparent materials by using specific laser radiation generated by serial combination of both generation regimes: a Q switched mode and a free-running mode.

U.S. Pat. No. 6,509,548 to Troitski discloses a method and apparatus for producing high-resolution laser-induced damage images inside transparent materials by small etch points. The method is based on generation of the initial electron density in the relatively large volume, creation of the breakdown at a small part of the said volume and control of the energy amount enclosed inside the plasma.

U.S. Pat. No. 6,605,797 to Troitski discloses laser-computer graphics systems for producing images such as portraits and 3D sculptures formed from laser light created etch points inside an optically transparent material. The produced image has a high resolution like a computer graphic image from which it is derived, little fluctuation in gray shades, and has no dissemble point structure.

U.S. Pat. No. 6,630,644 to Troitski et al. discloses a method for creating arrangement of damages for producing 3D laser-induced damage portraits with the space resolution, which is equal to the appropriate computer 3D model.

U.S. Pat. No. 6,664,501 to Troitski discloses a method for creating laser-induced color images within three-dimensional transparent material.

U.S. Pat. No. 6,670,576 to Troitski et al. discloses a method for producing laser-induced images inside transparent materials containing laser-induced color centers and laser-induced damages.

U.S. Pat. No. 6,720,521 to Troitski discloses a method for generating an area of laser-induced damage inside a transparent material by controlling a special structure of a laser radiation.

U.S. Pat. No. 6,720,523 to Troitski discloses a method for production of laser induced images inside transparent material, when complete image information is lacking before production and is supplemented only during production.

U.S. Pat. No. 6,727,460 to Troitski discloses a system for high-speed production of high quality laser-induced damage images inside transparent materials. The system produces the said images by the combination of an electro-optical deflector and means for moving the article or focusing optical system.

U.S. Pat. No. 6,734,389 to Troitski discloses an apparatus for producing high quality laser-induced images inside optically transparent material by controlling breakdown process development and space structure of laser radiation.

U.S. Pat. No. 6,768,080 to Troitski discloses a method for production of laser-induced images which are looked like iridescent images laying out white light incident upon them. These images are created by generation of laser-induced damages of special space form.

U.S. Pat. No. 6,768,081 to Troitski discloses a method and apparatus for producing high quality laser-induced images inside optically transparent material by using material processing made before and after image creation.

The purpose of the present invention is to disclose a method for creation of the laser show, which uses numerous effects, accompanying the interaction of laser radiation with balloons and gases, filling the balloons.

### SUMMARY OF THE INVENTION

The purpose of the present invention is the disclosure of a method for creation of a laser show by generation of laser-material interaction effects. This show reproduces a colored performance, where actors are the inflated lightweight objects (balloons). The method provides creation of dynamic laser pictures nearby and/or inside balloons, movement of the balloons into desirable directions and the destruction of these balloons.

This method provides the following conditions: 1) destruction of the objects is created by the laser radiation of minimal energy; 2) destruction of the objects is accompanied with desirable visual effects (blowing off, fragmentation, burning, explosion); 3) an inflated object, containing other inflated objects, is destroyed so, that the internal inflated objects are not damaged and they can move freely at ambient space; 4) destruction of the balloons is produced for both opaque and transparent surfaces; 5) destruction of inflated balloons is produced in the surface of their parts so that the balloons begin to move in the desirable direction.

The invention discloses a method wherein destruction of inflated objects is made by the joint action of internal gas pressure and the softening of object surfaces, which is provided by heating or surface material ablation, created by laser radiation. Another method for destruction of the balloons is based on the production of hot plasma accompanying the laser-induced breakdown process.

One or more embodiments of the invention comprise a method wherein laser-induced breakdowns are produced inside the predetermined areas by creating a medium at the said areas, which has lower breakdown threshold than the surroundings and by irradiating the areas with laser energy, which is lower than the breakdown threshold of the surroundings, but which is higher than the breakdown threshold of the said areas.

### DESCRIPTION OF THE DRAWINGS

FIG. 1 illustrates the production of laser-induced breakdowns inside the gas area B, which has the breakdown threshold lower than the thresholds of surface material and ambient air. Balloon A with transparent surface is irradiated by laser radiation, the energy of which is lower than the breakdown thresholds of surface material and ambient air but the energy is higher than the breakdown threshold of the gas, filling the balloon. The breakdowns are created at the gas near a balloon surface. The beam moves from position “a” to position “d” so that the sparks “a”, “b”, and “c” are created before the spark “d”.

FIG. 2 illustrates the production of laser-induced breakdowns near the surface of the inflated object inside the balloon A. This breakdown is used for destruction of the internal object without destruction of the external object with transparent surface. The ambient air, the surface material of an external balloon, and the gas area B have the breakdown thresholds, which are higher than the thresholds of the surface material of an internal object or/and a gas, filling this internal object. Balloon A with transparent surface is irradiated by laser radiation, the energy of which is lower than the breakdown thresholds of its surface material, ambient air and a gas, filling balloon A, but the energy is higher than the breakdown threshold of the surface material of object C or/and a gas, filling the object C.

FIG. 3 illustrates the creation of inflated balloon movement by destruction of the balloon part. The inflated balloon A contains three additional parts B, C, and D, which are separated from the Balloon A. Laser beam produces a hole in surface of part D. A gas flow from the hole creates reactive force, which moves the balloon A.

FIG. 4 illustrates the Star War laser show with inflated lightweight balloons having spaceship forms. At the beginning, a laser radiation has low power to destroy the spaceships and laser beams are used for an illusion of the laser fire. At the appointed time, the used laser radiation has high power and the spaceships are destroyed.

FIG. 5 illustrates the second act of the Star War show, which begins after the spaceships have been destroyed. The space arrivals, which have been inside the spaceships, are now free and continue to exchange fire with the enemies.

### DETAILED DESCRIPTION OF THE INVENTION

The invention comprises a method for creation of the laser show, which uses inflated lightweight objects (balloons) for generation of dynamic visual effects, arising from interaction of laser radiation with the material. These effects are the bright pictures created near the object surfaces and the destruction of these objects. Combination of destruction effects and bright pictures provides the creation of specific laser performance, where actors are inflated balloons.

Creation of desirable dynamic color effects is provided by production of balloons with special characteristics (of shapes, surface materials and gases, filling the balloons) and generation of corresponding laser radiation.

Peculiarity of the methods for the destruction of the inflated objects by laser radiation is the use of the gas pressure and physical characteristics of a gas, filling the lightweight objects, coupled with the laser-material interaction. These methods provide the following conditions: 1) destruction of the objects is created by the laser radiation of minimal energy; 2) destruction of the objects is accompanied with desirable visual effects (blowing off, fragmentation, burning, explosion); 3) an inflated object, containing other inflated objects, is destroyed so, that the internal inflated objects are not damaged and they can move freely at ambient space; 4) destruction of inflated objects is provided for both opaque and transparent surfaces; 5) destruction of inflated balloons is produced in the surface of their parts so that the balloons begin to move in the desirable direction.

One or more embodiments of the present invention are methods for destruction of a gassy balloon by softening its surface so that internal gas pressure bursts the surface at the softened area. As a result of this laser-material interaction, a surface hole is created and a balloon is deflated. The softening of an opaque surface is provided by local laser heating of this surface or by laser ablation and laser evaporation of its material. In this case, balloon surface is produced from material, which has high absorptivity, or the balloon surface material has special additions, which keep the elasticity of the surface material and increase its absorptivity.

The softening of a surface, which is transparent for laser radiation, is produced by the creation of laser-induced breakdown in the surface material, or in ambient air, or in the gas filling the balloon.

For production of the breakdown in the surface material, balloon surface is produced from the material, the breakdown threshold of which is lower than the breakdown threshold of ambient air. In this case, the breakdown of surface material is created automatically, when laser beam penetrates into the surface, without special focusing of the beam. The feature of the laser-induced breakdown of the thin transparent surface is the generation of entrance and exit surface plasma accompanied by a bright flash of light, which comes from a plasma spark at the surface. Spectra taken of surface plasmas show that the light contains spectral lines characteristic of the material being irradiated.

For production of the breakdown in the ambient air, the surface material has additions, which create a cloud of molecules or other small parts near the surface. For example, such additions are different volatile compounds. The creation of a more dense cloud is produced by using laser radiation, which interacts with the additions efficiently, and only after the laser radiation, generating the laser-induced breakdowns, is directed to the balloon. The breakdown of the ambient air can produce a hole both in transparent and opaque surfaces. If laser-induced breakdowns are generated inside a gas, filling a balloon, the parameters of the gas is determined so that its breakdown threshold is lower than the breakdown threshold of ambient air and transparent material. This condition provides gas breakdown creation without special focusing of laser radiation inside a balloon and without using intersection of several laser beams.

A hole by generating laser-induced breakdown is created as a result of both surface softening, produced by heating from a breakdown spark (plasma inside a the breakdown spark has temperature of several thousands) and the pressure of a blast wave arising during the breakdown.

Laser-induced breakdown plays an important role in creation of dynamic effects. Generation of the breakdown at the predetermined area is provided by focusing of laser radiation or by intersection of several laser beams at the area, so that the laser energy of a focal spot (or intersection areas) increases the breakdown threshold of the predetermined areas but does not increase the breakdown threshold of the surroundings. However, both focusing laser radiation and intersection of several beams are complicated technical problems, when the predetermined areas are distant from a laser.

One or more embodiments of the present invention are method for production of laser-induced breakdowns inside the areas without focusing laser radiation and without using intersection of several laser beams by creation of the medium at the said areas, which has lower breakdown threshold than ambient air, and by generating laser radiation with energy, which is lower than breakdown threshold of the ambient air, but which is higher than the breakdown threshold of the medium of the said areas.

The method gives a chance to produce breakdowns inside desirable areas without focusing laser radiation at the areas and without intersection of several beams. In particular, laser-induced breakdowns inside gas, filling a balloon with transparent surface, are created by using gas, the breakdown threshold of which is lower than the breakdown threshold of the ambient air and the surface material. Laser-induced breakdowns are created inside transparent surface material without focusing laser radiation, if the breakdown threshold of the material is lower than the breakdown threshold of ambient air. Laser-induced breakdowns are created near the balloon surface if the corresponding surroundings has the breakdown threshold, which is smaller than the breakdown threshold of the ambient air. Sizes of breakdown sparks generated by this method are determined by the beam diameter.

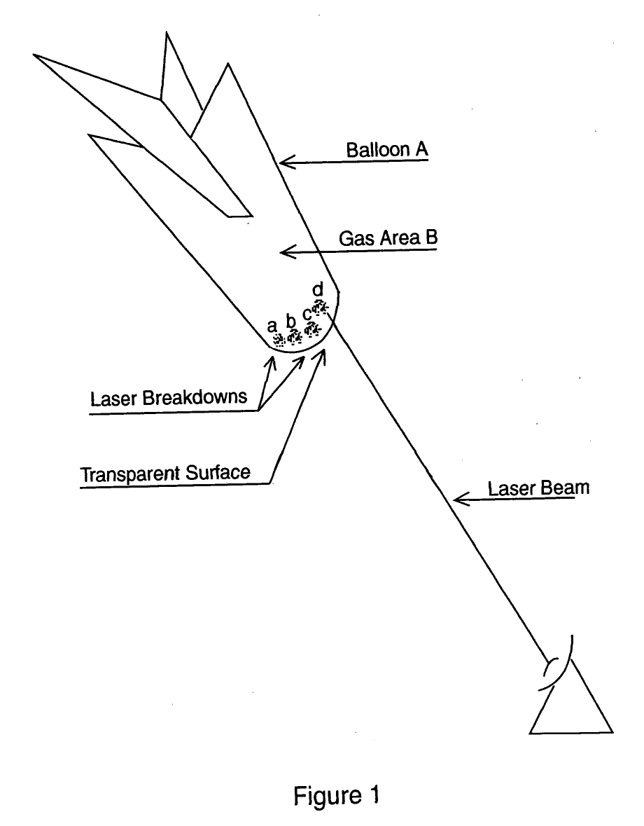

FIG. 1 illustrates this method by the example of production of laser-induced breakdowns inside a balloon. The area B, which contains gas filling the balloon, has the breakdown threshold lower than the thresholds of surface material and ambient air. Balloon A with transparent surface is irradiated by laser radiation, the energy of which is lower than the breakdown thresholds of surface material and ambient air but the energy is higher than the breakdown threshold of the gas, filling the balloon. The breakdowns are created at the gas nearby a balloon surface. The beam moves from position “a” to position “d” so that the sparks “a”, “b”, and “c” are created before the spark “d”.

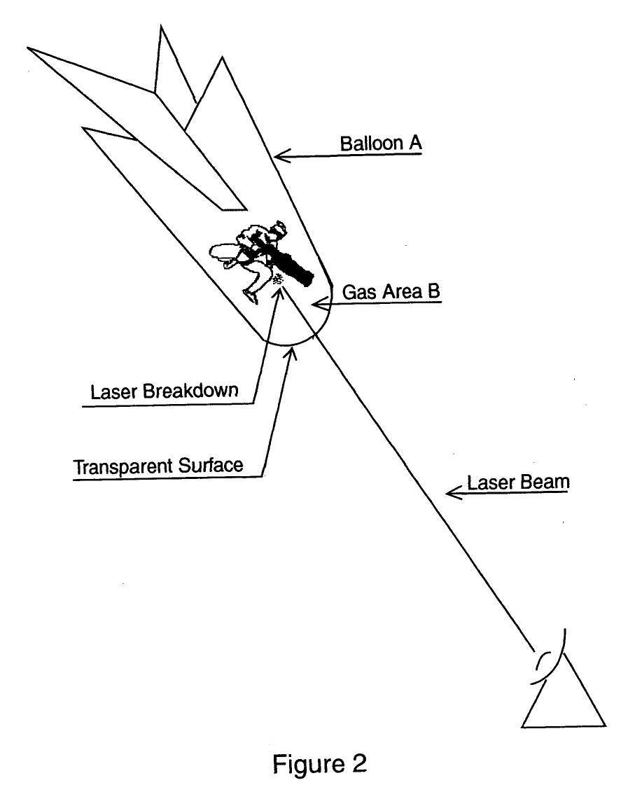

FIG. 2 illustrates this method by the example of production of laser-induced breakdowns near the surface of object inside the general balloon. This breakdown can be used for destruction of the internal object without destruction of the external object with transparent surface. The surface material of an external balloon and a gas of area B have the breakdown threshold, which is higher than the thresholds of surface material of an internal object or/and a gas filling this internal object. Balloon A with transparent surface is irradiated by laser radiation, the energy of which is lower than the breakdown thresholds of its surface material, ambient air, and a gas, filling balloon A, but the energy is higher than the breakdown threshold of the surface material of object C or/and a gas, filling the object C.

One embodiment of the invention is a method wherein shape of a balloon surface is produced so that the surface (or its parts) is able to focus or to reflect the laser radiation. For example, the spaceship fuselage of FIG. 2 can be produced so that the laser radiation is focused near the object C. A balloon surface can have hemisphere cavities, which focus laser radiation forward of the surface, where breakdown sparks are created. A balloon surfaces can have mirror parts, which reflect light and create illusion of firing.

The hole, which is created by laser radiation, is also used to set in motion a balloon. The general balloon has a special part, which is separated from the general balloon. Laser beam is directed to the auxiliary part for creation of a hole in the part surface. An efflux, generated by the flow from a hole, sets in motion the general balloon. A general balloon can have several separated parts, which are located so that the creation of holes in different parts gives a chance to generate different movement direction or to control the movement direction.

The movement direction of the general balloon is determined by the auxiliary part, in which a hole is produced and by the location of the hole on the surface of the parl The control of the general object speed is produced by controlling the laser beam diameter, which determines the sizes of a hole.

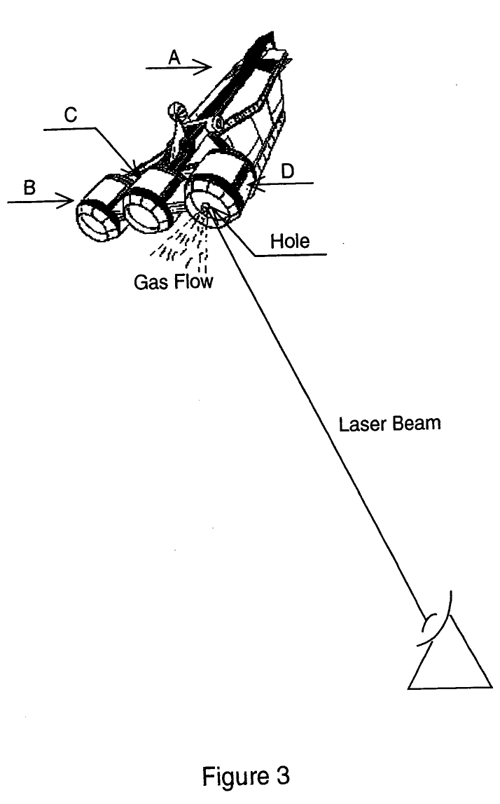

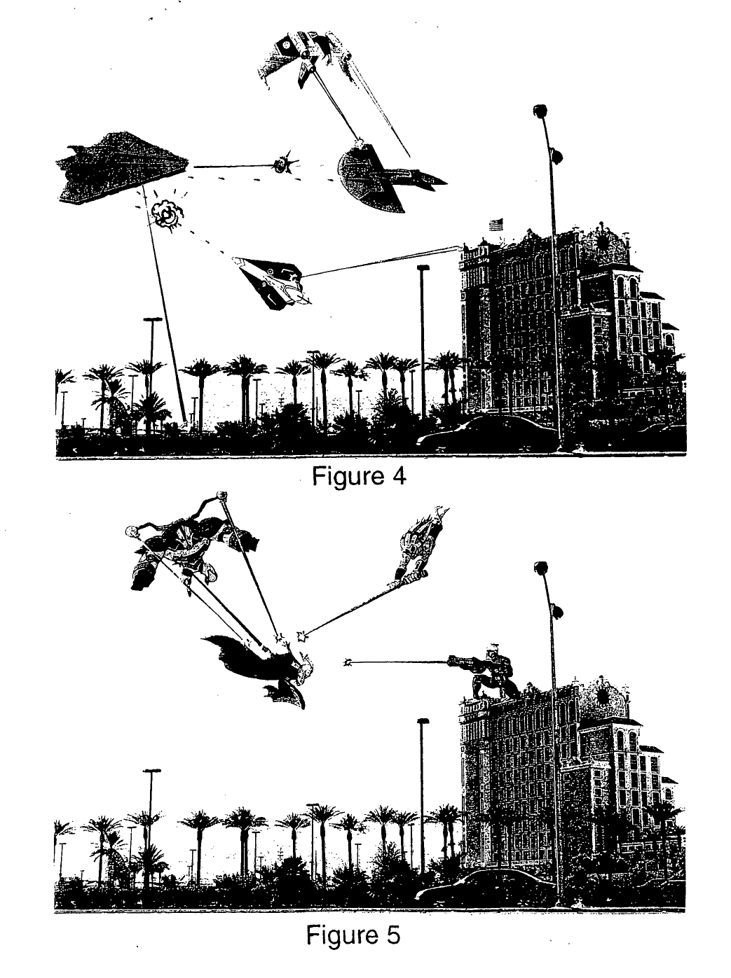

FIG. 3 illustrates the method of motion generation for the general balloon A, which has the auxiliary part B. Laser radiation produces a hole in the auxiliary part surface B and gas flow from this hole creates jet thrust, which moves the general balloon A. The energy of the laser beam, its direction and its cross-section sizes are determined in such a way as to create a hole of pre-set sizes and pre-set surface location. The sizes of the hole coupled with gas pressure of part B determine the balloon speed, and the location of the hole determines its movement direction.

The auxiliary parts can also contain special gas and dust, which after destruction of the auxiliary parts create gas and dust clouds around the general balloons. Gas composition and dust characteristics are determined so as their breakdown threshold is lower than the breakdown threshold of ambient air. It provides the laser-induced breakdown creation near the general balloon surface without focusing the laser radiation at this area.

Ascent of a balloon can be provided by the laser heating the gas, which fills the balloon. The heating can be produced as a result of absorption of laser radiation by balloon gas (for transparent surfaces), or by surface material (for opaque surfaces). Also, the heating can be produced by creating an arrangement of laser-induced breakdowns of the gas, filling a balloon with transparent surface.

Sometimes, the production of a surface hole does not create the visual effects, which are needed for a laser show. Balloon destruction by creating a hole is not deeply impressive. Moreover, balloons can contain other balloons, which should move at the ambient space freely after destruction of exterior balloons. The free movement of internal balloons is provided by incision of the external balloon surface. It can be produced by creating softening of the balloon surface along the lines, which divide the surface into several parts. The softening lines are created by the corresponding movement of the laser beam. The speed of the beam movement should be high enough, so that the creation of softening lines is produced over a short period until the balloon bursts.

Impressive destruction effect is created when laser radiation sets fire to the balloon surface. In this case, the surfaces of inflated objects contain inflammable material, which bursts into flames under the action of high temperature. Needed temperature of a local area of an opaque surface is created by the absorption of the laser radiation or by the generation of laser-induced breakdowns in immediate proximity to the surface. High temperature of a local area of a transparent surface is created by generation of laser-induced breakdowns in ambient air, or in surface material, or in the gas, filling the balloon.

Impressive destruction effect is also created, when laser radiation blows up a balloon. In this case, the gas, which fills the balloon, is explosive or contains explosive dust, which is exploded under the action of laser radiation.

The balloons utilized during the laser show are also used for creation of dynamic laser pictures, which are produced on balloon surfaces, near the surfaces or inside balloons, if they have transparent surfaces.

Pictures near the surfaces or inside balloons, if they have transparent surfaces, are created by generating an arrangement of breakdown sparks. A spark arrangement is produced by moving the laser beam along the area, the breakdown threshold of which is lower than the breakdown threshold of the surroundings. Such areas near the balloon surface are created by using special surface material or by generating clouds of molecules and small particles which appear as a result of destruction of balloon parts.

Pictures on the opaque surfaces are created by using surface material with special characteristics and invisible laser radiation. For example, the surfaces containing fluorescent material or phosphorescent pigment begin to sparkle when invisible light irradiates them. Analogously, dynamic pictures can be created in gas, filling balloons with transparent surface, if the gas contains fluorescent dust, which is lighted under the action of black laser radiation.

Another method of image creation inside transparent surfaces and gases filling the balloons is based on photoionization phenomenon as a result of which color centers are generated. Photoionization of different transparent materials is possible under infrared high-power femtosecond (about 100 fs) pulses. It is very important that in this case, color centers are generated by laser pulses at irradiance below the thresholds of laser-induced breakdowns.

A method for creation of the laser show, where controlled laser radiation is used for destruction of inflated lightweight objects and for creation of light visual effects, comprises the following steps:

Step 1. Determination of the laser-material interaction mechanisms, which are used for creation of the laser show to generate light visual effects and to destroy inflated lightweight objects.

The laser-material interaction mechanisms are determined so as to create 2D and 3D images on surface, near the surface and inside inflated balloon by using invisible (black) laser radiation and so as to destroy the balloons. Destruction of the balloons should satisfy the following conditions: 1) the minimal laser energy; 2) impressive visual effects; 3) inflated object, containing other inflated objects, is destroyed so, that the internal balloons are not damaged and they can move freely at ambient space; 4) destruction of inflated objects is provided for both opaque and transparent surfaces; 5) destruction of inflated balloons is produced in parts so that the rest parts are not damaged and begin to move in the desirable direction.

Destruction effects, mentioned above are provided by using different combinations of laser-material interaction mechanisms such as heating, melting, vaporization and pressure of blast wave generated by laser-induced breakdown. Analogous mechanisms are used for creation of the balloon movement at the desirable direction.

Light visual effects are created by using different combinations of laser-material interaction mechanisms such as gas fluorescence, photoionization, surface material luminescence and breakdowns inside air, transparent surface materials and gases, filling balloons.

Step 2. Determination of structure and composition of the inflated object surfaces needed for the generation of the light visual effects, produced by laser-material interaction mechanisms, and creation of such surfaces.

From point of view of a laser show, the surface characteristics should satisfy two conditions: 1) the surfaces can be used for creation of laser-images on surfaces, or near the surfaces, or inside balloons and 2) the surfaces should provide desirable effects accompanying balloon destruction by laser radiation.

Surface materials for generation of surface images by using invisible laser radiation are produced by creation of opaque materials which contain fluorescent material or phosphorescent pigment so that the balloon surfaces begin to sparkle when black light irradiates the surfaces.

Surface materials for generation of laser-induced images by generation breakdowns near the balloons are produced by adding volatile compounds. Such surfaces create clouds of molecules or other micro-parts nearby surface. This reduces the breakdown threshold of ambient air, which is close to the surfaces; so that the value of the breakdown threshold nearby surfaces is lower than the breakdown threshold of the distant air

Balloon surfaces for generation of laser-induced images by generation of breakdowns inside the surface are produced from material, the breakdown threshold of which is lower than the breakdown threshold of ambient air.

Surface materials for generation of laser-induced images by generation of breakdowns inside balloons are transparent for the used laser radiation and have breakdown threshold, which is higher than the breakdown threshold of the gas filling the balloons.

The opaque surfaces, where a hole is produced, are made from materials having high absorptivity. The absorptivity is increased by using special additions, which keep the elasticity of the surface material and raise its absorptivity.

The surfaces of inflated objects, which are destroyed by firing, contain inflammable material, which is burst into flames under the action of laser radiation.

Step 3. Creation of the gas and its compounds, filling the balloons, utilized during a laser show.

Gas filling a balloon with transparent surface is colored or contains fluorescent dust, which is lighted under the action of black laser radiation. In this case, images inside the balloon are created by moving laser radiation.

Gas, filling the lightweight objects, is flammable gas, which is burst into flames under the action of laser radiation. Such gas gives a chance to destroy the objects by setting fire to these objects by directing laser radiation onto them.

Gas filling the lightweight objects is explosive gas or gas with explosive dust, which is exploded under the action of laser radiation.

Gas filling objects with transparent surfaces has the breakdown threshold, the value of which is lower than the breakdown threshold of material surfaces and ambient air.

The gas pressure is determined so that the gas rends the balloon surfaces, which are softened by laser radiation, to pieces.

Step 4. Creation of lightweight gassy objects, having shapes and surfaces with predetermined characteristics.

Lightweight gassy objects have shapes needed for the laser show and can enclose several other gassy objects. Also, a lightweight gassy object can be composed from several separated parts, so that destruction of a part does not destroy others. These parts can be used to set in motion a whole gassy object. These parts are located so that laser radiation is able to produce a hole in a surface of a part and arisen gas flow creates the necessary reactive force.

Step 5. Determination of laser radiation characteristics needed for the generation of the light visual effects by the interaction of laser radiation with the gas and surfaces of inflated objects.

Laser radiation for production of a hole of opaque surfaces has the following characteristics:
wavelength corresponds to high absorption of the surface material;
radiation time (pulse duration and pulse repetition) and laser energy provide such local softening of the surface material that internal gas pressure tears the surface at the softened place.
diameter of the laser beam near the surface is equal to the size of a necessary hole.

In case when laser radiation and internal gas pressure are used for rending a balloon surface to pieces the radiation time and laser energy are determined so that production of necessary softened surface lines is made for time period while the balloon preserves its shape.

A hole of transparent surface is produced by laser radiation, which has the following characteristics:
pulse duration and pulse energy are determined so that the laser radiation does not create the breakdown at the air but generates the breakdown near the balloon surface or in the surface;
total laser energy (the number of laser pulses) is determined so that the breakdown has sufficiently great power to produce a hole.

Laser radiation for firing the opaque surfaces, containing inflammable material, has wavelength, which is absorbed by the surface material, and energy, which has sufficiently value to heat the surface and to fire the inflammable material.

Laser radiation for destruction of a balloon by the explosion of a gas filling the balloon with transparent material does not generate breakdowns at the ambient air and generates breakdowns at the gas. The pulse duration, number of pulses and total laser energy are determined so that the power of the breakdown plasma is sufficient to detonate the explosive gas or explosive dust, contained in the balloon.

Laser radiation for production of pictures on the balloon surfaces has wavelength, which corresponds to invisible radiation and which stimulates luminescence of fluorescent material or phosphorescent pigment contained in the surfaces.

Laser radiation for production of pictures inside a gas, filling a balloon with transparent surface, has wavelength, which corresponds to invisible radiation and which stimulates luminescence of fluorescent dust, contained in the gas, or creates color centers.

Step 6. Generation and formation of laser radiation and direction of laser radiation at the predetermined area of laser show scene.

Step 7. Control of laser radiation characteristics for changing light visual effects and destroying inflated objects during the laser show.

During a laser show, laser radiation is used for creation of dynamic pictures and for destruction of inflated balloons and these acts alternate. The task of step 7 is control of laser radiation characteristics during the laser show for generation of needed visual effects in accordance with laser show program. In particular, control of laser radiation provides the creation of laser pictures with laser energy lower than destruction threshold, but balloon destruction is produced by a laser energy increasing this threshold.

We claim:

1. A method for creation of laser show, where controlled laser radiation is used for destruction of inflated lightweight objects and for creation of light visual effects, comprising:
Determination of the laser-material interaction mechanisms for creation of the laser show by generating light visual effects and destroying inflated lightweight objects;
Creation of inflated object surfaces, characteristics, structure and composition of which provide the visual effects generated by the laser-material interaction mechanisms;
Creation of the gas and its compounds, which fill the balloons, utilized during a laser show;
Creation of lightweight objects having shapes, surfaces and auxiliary inflated parts with the predetermined characteristics;
Determination of laser radiation characteristics needed for the generation of the light visual effects by the interaction of laser radiation with the surfaces of inflated objects, ambient air and the gas filling the objects;
Generation, formation and direction of laser radiation at the predetermined area of the laser show scene;
Control of laser radiation characteristics for changing light visual effects and destroying inflated objects during the laser show.

2. A method in accordance with claim 1 wherein balloons with special shapes, surface materials and gases, which fill the balloons, are used for production of color dynamic visual effects generated by laser radiation.

3. A method in accordance with claim 2 wherein the color dynamic visual effects are produced by creation of laser pictures on or inside the balloons, by moving the balloons, and by destruction of the balloons.

4. A method in accordance with claim 1 wherein destruction of inflated objects is made by the joint action of internal gas pressure and softening of their surfaces, which is provided by heating or surface material ablation created by laser radiation.

5. A method in accordance with claim 4 wherein rending a balloon surface to pieces is produced by creation of softened surface lines, which are generated by moving the laser beam along the surface so that the production of necessary softened surface lines is made for time period while the balloon preserves its shape.

6. A method in accordance with claim 5 wherein softened lines are located on a surface so that the internal inflated objects are not destroyed and so that the fragments of the destroyed external surface do not prevent the movement of the internal objects.

7. A method in accordance with claim 1 wherein hot plasma accompanying the laser-induced breakdown process is used for destruction of the inflated objects.

8. A method in accordance with claim 1 wherein laser-induced breakdowns are produced inside the predetermined areas by creating a medium at the said areas, which has lower breakdown threshold than the surroundings and by irradiating the areas with laser energy, which is lower than the breakdown threshold of the surroundings, and which is higher than the breakdown threshold of the said areas.

9. A method in accordance with claim 7 wherein breakdowns at the gas, filling a balloon with transparent surface, are produced by using the gas, which has breakdown threshold lower than the breakdown thresholds of the ambient air and the surface material, and by irradiating the areas with laser energy, which is lower than breakdown thresholds of the ambient air and transparent material, and which is higher than the breakdown threshold of inflated gas.

10. A method in accordance with claim 1 wherein the breakdown threshold of ambient air, which is close to the balloon surfaces, is reduced by creation of clouds of molecules or small particles around the balloons.

11. A method in accordance with claim 10 wherein the clouds of molecules and small particles are created by using special surface material or by a gas flow containing the special micro-particles coming from a hole, which is produced by the laser radiation in a surface of an auxiliary balloon part.

12. A method in accordance with claim 1 wherein destruction of balloons with opaque surfaces, containing inflammable material, is produced by the laser radiation, which is absorbed by the surface material, and the energy of which has sufficient value to heat the surface and to set fire to the inflammable material.

13. A method in accordance with claim 1 wherein destruction of balloons, filled by explosive gas or explosive dust, is produced by laser radiation, which does not generate breakdowns at the ambient air but generates breakdowns at surface material or internal gas, so that the power of the breakdown plasma is sufficient to detonate the explosive gas or explosive dust, containing the balloon.

14. A method in accordance with claim 1 wherein a general lightweight inflated object has one or several auxiliary inflated parts separated from the general balloon and located so, that a gas flow from a hole, which is produced by laser radiation in a surface of an auxiliary part, sets in motion the general object.

15. A method in accordance with claim 14 wherein movement direction and speed of a general balloon are controlled by the location of a surface hole on an auxiliary part and by the diameter of the laser beam, which produces the hole.

16. A method in accordance with claim 1 wherein surface pictures produced by invisible laser radiation on the inflated object surfaces containing fluorescent material or phosphorescent pigment, which begin to sparkle when invisible light irradiates the surfaces.

17. A method in accordance with claim 1 wherein pictures inside the gas, which fills a balloon with transparent surface and contains fluorescent dust, are created by irradiation of the balloon with wavelength, under action of which the gas is lighted.

18. A method in accordance with claim 1 wherein an arrangement of laser-induced breakdown sparks creates the bright pictures near the balloon surface or inside the gas inflating the balloon.

19. A method in accordance with claim 1 wherein shape of a balloon surface is produced so that the surface (or its parts) is able to focus and to reflect the laser radiation.
